(19) United States
(12) Patent Application Publication
(10) Pub. No.: US 2007/0294968 A1
(43) Pub. Date: Dec. 27, 2007

(54) Wooden Material Panel Comprising A Soft Plastic Layer

(76) Inventor: Roger Braun, Willisau LU (CH)

Correspondence Address: BACHMAN & LAPOINTE, P.C., 900 CHAPEL STREET, SUITE 1201, NEW HAVEN, CT, 06510, US

(21) Appl. No.: 10/569,313

(22) PCT Filed: Aug. 20, 2004
(86) PCT No.: PCT/EP04/09350

§ 371 Date: Mar. 23, 2007

(30) Foreign Application Priority Data
Aug. 20, 2003 (DE) 103 38 854.0
Jun. 29, 2004 (DE) 10 2004 031 547.7

(51) Int. Cl. E04B 1/00; B05D 7/06

(52) U.S. Cl. 52/284; 52/309.1; 52/515

(57) ABSTRACT

The invention relates to a wooden material panel, in particular a wall, ceiling or floor panel, comprising a surface coating that is applied in at least some sections. The coating contains at least one layer of plastic with a Shore hardness A of up to 90, preferably up to 80, in particular up to 65, preferably up to 50, especially between 20 and 60 and more specifically between 30 and 40. The invention also relates to a method for producing the wooden material panel.

The invention relates to a wooden material panel, in particular wall, ceiling or floor panels, comprising a surface coating.

Wooden material panels, for example produced from chip board, high- or medium-density fibre board or the like, manufactured on the basis of wood, are used for numerous purposes. They are employed as window sills or kitchen working surface panels, but in particular also as panels for furniture parts, e.g. front panels, but also as wall, ceiling or floor panels. The edges are frequently provided with a tongue and groove profile.

Such panels usually have a decorative surface, coated with a plastic layer. The plastic should have a particularly high resistance against mechanical, thermal and/or chemical wear. Wear resistance against abrasion, cigarette burns and/or domestic cleaning agents as well as water or water vapour are important properties which must be met.

Whereas known wooden material panels meet the aforesaid requirements without any problems and, in view of their decoratively finished surfaces, are usable for multiple purposes, they nevertheless suffer from disadvantages in relation to their acoustic properties, which may prove of quite decisive importance in making a purchasing decision. It is found to be particularly disadvantageous in the case of floor, wall and ceiling panels that these boards or panels have a very disadvantageous effect on space and footstep acoustics. The noise level when walking on such surfaces (typically: laminate floors) is very high and is conceived as unpleasant. The lack of sound damping ability of such wall or ceiling panels or boards renders premises unpleasantly noisy.

It is therefore an object of the invention to provide a wear resistant wooden material panel, the interior acoustic properties of which can be adjusted to meet specific objectives.

The degree of acoustic damping, including that of damping footstep noise, should be adjustable, depending on the prospective employment and purpose of use of the wooden material panel and is to extend even to wall or ceiling or floor boards which can be considered as “noiseless”, which, accordingly, dampen by far the major part of noise generated, e.g. by footsteps, talking and/or by media.

Besides the degree of sound damping, it is furthermore intended to render adjustable a further interior acoustic property. According to the invention it is intended for the sound pattern of natural substances to be imitated in a planned manner. For example, the noise pattern which arises e.g. when walking on natural stone, cork or parquet should be adjusted exactly.

The present object is attained by the provision of a wooden material panel, in particular a wall, ceiling or floor panel comprising a surface coating applied at least to sections thereof, including at least one layer of plastics having a Shore hardness A up to 90, preferably up to 80, more preferably up to 65, advantageously up to 50. Layers of plastics having a Shore hardness A of 20 to 60, preferably of 30 to 40, have been found to be particularly suitable. In the following, this layer will be referred to as “layer of plastics of low hardness”. The Shore hardness is tested in accordance with DIN 53505 and reflects a measure of hardness of test bodies and products made of elastomers and plastics. It is determined by the penetration of a defined testing body having a defined spring loading into the surface of a body to be tested, in this case a wooden material panel having a surface of plastics. Substances, the Shore hardness of which is listed in class A, are particularly soft substances. Substances of greater hardness are listed in Shore hardness classes B, C and D.

Known wooden material panels are provided with surfaces as hard as possible, because hard plastics surfaces are particularly resistant against the aforesaid forms of wear. However, the hardness of the surface is not desirable in all cases, be it, because such surface would have a cold or slippery feel, or be it, because such coating in subsequent processing of the surface will be brittle. Since the hardness of the surface makes possible a particularly high sound reflection or conduction of footstep noises, the poor sound damping performance is substantially influenced by such hardness.

In accordance with the invention the layer of plastics has a low hardness, this means that as compared with known coatings, e.g. varnish coatings, such layer is very soft. A layer of plastics having a Shore hardness A of 90 or less, to a person skilled in the art will initially be believed to be inadequately wear resistant for the manufacture of a wear resistant wooden material panel; however, tests have shown that even surfaces having a very much lower hardness can comply very readily with the aforesaid conditions in respect of wear resistance of the coated wooden material panel against mechanical, thermal and/or chemical stressing.

The resistance against the effects of acids and/or alkalis, water, oils and the like as well as the abrasion resistance, in particular when acted upon by chair castors, make it possible to employ the wooden material panel according to the invention in the same broad fields of application for which the previously known panels with hard surface coatings were suitable. In this context—particularly under mechanical load—the substantially improved sound damping performance of the “soft” surface is notable.

Even “soft” surfaces of plastics of low hardness are fading resistant as well as UV-resistant. As a rule, the surface coatings are transparent in order not to obscure the decorations applied to the wooden material panels. Surprisingly, it was found that the depth action of printing is improved by a surface provided with a “soft” plastics coating. This results in improved possibilities for decorative surface designs.

It was furthermore found advantageous that a surface of reduced Shore hardness which has a “softer” feel, makes possible a substantially improved damping effect on footstep noise and interior noise levels. This is of great importance, in particular when using such wooden material panels with surfaces of reduced hardness as floor panels, typically laminated floors.

The feel of the surface according to the invention is not only softer, but it is also warmer and will subjectively therefore be felt as more pleasant. This parameter as well is of great importance for the use of wooden material panels. In premises where people walk barefoot or in which people frequently sit on the floor (children and youth rooms, sports halls, gyms and therapy rooms or the like) a pleasant, cosy occupant feel is of particular value.

Preferably the at least one layer of plastics of low hardness is manufactured of thermoplastic plastics or a mixture of plastics, which contains at least one thermoplastic plastics. Thermoplastic plastics can be processed readily and have a Shore hardness A in the aforesaid range.

In the alternative, the layer of plastics may be manufactured from a polyolefin, a reactive polyolefin (POR), a polyurethane (PU), for example a polymer diphenylmethane diisocyanate (PMDI), an ethylene-vinyl-acetate (EVA), an epoxide or a polyester. These starting materials are preferably employed in powder form or as hot melts. The layer may also be manufactured from a mixture of the aforesaid substances or from a mixture of plastics using at least one of the aforesaid plastics. Numerous known polymers and/or polymer mixtures are familiar to the person skilled in the art, which are generally suitable for the coating of surfaces of wooden material panels. The unusual selection of plastics in accordance with the invention according to the attainable surface hardness in the region below 90 Shore hardness A, preferably below a Shore hardness A of 80, particularly preferred below a Shore hardness A of 65, and very specifically preferred a Shore hardness A of 50, advantageously in the range of 20 to 60, preferably of 30 to 40, can be made by simple coating and loading experiments. The properties of plastics being pure products or as mixtures can be adjusted very exactly, so that the desired Shore hardness A, but also other properties such as transparency, processing conditions, setting periods, compatibility with other materials and the like can be adjusted as desired.

According to a further preferred embodiment of the invention, the layer of plastics of low hardness can be manufactured from a plastics or a mixture of plastics, which is/are transparent, provided with a filler, in particular a mineral or organic filler and/or colouring. In this manner, it is possible to provide the surface of the wooden material panel—in any parts that are coated—with numerous surface finishes.

Even layer thickness of 20 μm for the layer of plastics of low hardness are adequate in order to attain, even with softer layers, a good resistance against various forms of wear. In this context the “soft” plastics coatings can be applied using the same application methods as for known plastics coatings. According to the invention, the thickness of the coatings of plastics may be as much as 300 μm, preferably up to 40 μm, particularly preferred up to 70 μm, advantageously up to 100 μm, particularly advantageously up to 150 μm, in particular up to 250 μm.

According to an advantageous further embodiment of the invention, the at least one layer of plastics of low hardness forms part of a multiple layer surface coating on a surface of the wooden material panel. A wooden material panel, as a rule, has two main surfaces, a front and a rear side. The side edges are also part of the surface, even though for numerous purposes it is not necessary to provide the side edges with the coating according to the invention. Accordingly, in the context of this invention, the expression surface always denotes the front and/or rear side, without, however, excluding the side edges. According to the state of the art, surface coatings for wooden material panels are common which are composed of a plurality of layers. Usually, these are layers of different materials. This laminar structure can also be employed advantageously within the scope of the present invention. The at least one layer of plastics may, according to the invention, form part of a multiple layer surface coating of the wooden material panel.

The layer of plastics according to the invention, in this context, may thus be integrated as an exterior or non-exterior layer within the surface coating of the wooden material panel. It was found that for setting the interior acoustic parameters, it is not necessary for the layer of plastics of low Shore hardness A to be applied to the outside. The advantageous effect of this invention is also attained if the layer of plastics is applied, for example, between a printing ink application and an exterior varnish layer.

The wooden material panel according to the invention can be further improved in that at least two layers of plastics having a Shore hardness A below 90, preferably having a Shore hardness A below 50, form part of the surface coating. In this context, the at least two layers can be provided either on the same side of the wooden material panel or on different sides, e.g. on the front and on the rear of the wooden material panel, that is to say on the main surfaces of the wooden material panel. In the event that two layers of plastics of low hardness have been applied onto the same surface of the wooden material panel, these may be applied immediately one on top of the other. This may, for example, be appropriate if thin coatings of the plastics can be more readily applied or if other processing advantages apply. If desired, it is also possible for one or more layers of a different material to be applied between the at least two layers of the plastics of low hardness. This may, for example, apply to paint layers, varnish layers, layers including pigments, or a layer of a material having a different Shore hardness A. Such a multiple layer structure of the surface coating is found to be particularly advantageous if the interior acoustic effect of natural substances is to be imitated.

Within the scope of the invention it is considered particularly advantageous if in the case of a multiple layer surface coating the at least one layer of plastics adjoins a layer of synthetic resin. The synthetic resin layers include, in particular, varnish layers having a substantially greater Shore hardness A than the layer of plastics according to the invention. Such layers of synthetic resin may be provided above or below the layer of plastics. Even if the layer of plastics is not provided on the outside, its interior acoustic effect is maintained substantially and is not obscured by the layer of synthetic resin.

In the same way, the layer of plastics of low hardness may adjoin a layer of paint or pigments. Here as well, the sequence of layers in the surface coating between the surface of the wooden material panel and the outermost layer of the surface coating can be freely selected in accordance with the desired interior acoustic properties. Thus it is, for example, possible for a single or multiple layer paint coating to be applied onto the surface of the wooden material panel on top of which a layer of plastics of low hardness is applied. The layer of plastics in that case is preferably transparent in order not to obscure the paint coating.

In the event that the layer of plastics of low hardness fails to adhere to the particular substrate onto which it is to be applied, such substrate may first be treated with a suitable bonding agent. Within the scope of the presently described embodiment it is e.g. possible to apply a bonding agent onto the paint coating prior to the application of the layer of plastics of low hardness.

If the surface is subjected to special requirements regarding e.g. abrasion resistance, it is possible to incorporate in the surface according to the invention, conventional additives such as corundum or other particles.

The layer of plastics of low hardness is at the same time elastic. It accordingly possesses restoration forces, which ensure that deformations resulting from applied forces are at least substantially undone once these forces have been reduced. This is in particular of advantage in the event of point loading, which in the case of rather hard surface coatings results in cracks or fractures in the coating. Surprisingly, this elasticity is not lost if on top of the layer of plastics of low hardness a surface coating of greater hardness is applied. The restoration of elastic deformations does not take place instantaneously, but within hours or days, depending on the nature of the selected plastics of low hardness, as well as the nature of loading. The described positive effects are measurable in spite of the usually small layer thicknesses of about 100 μm up to about 300 μm.

The invention further relates to a process for the manufacture of wooden material panels, including a surface coating applied to at least parts thereof, in which at least one layer of plastics is applied having a Shore hardness A of up to 90, preferably up to 80, particularly preferably up to 65, advantageously up to 50, particularly advantageously of 20 to 60, preferably 30 to 40.

According to an advantageous further development of the inventive concept, the layer of plastics is applied in a thickness of between 20 μm and 300 μm, preferably up to 40 μm, particularly preferably up to 70 μm, advantageously up to 100 μm, particularly advantageously up to 150 μm, in particular up to 250 μm. In spite of the relatively thin layer thickness a noticeable interior acoustic effect is attained, in particular an improved sound damping. Depending on the nature of the plastics of low hardness and the manner in which the at least one layer of plastics of low hardness is provided, the sound dampening effect of the layer applied according to the invention can be optimised in accordance with the particular preconditions by simple experiments. Alternatively, in the same manner, the acoustic effect of various natural substances may be imitated.

It has furthermore been found to be advantageous for the layer of plastics according to the invention to be elastic, in particular after the reduction of a mechanical load which has brought about a deformation, thus e.g. after an impact or compressive load to resume the original shape. Such a visco-plastic layer is impact resistant, abrasion resistant and scratch resistant. According to a preferred embodiment, a residual imprint of between 0.5 and 4%, preferably 0.5 to 2% of the imprint under load, measured under the conditions of DIN-EN 433 is retained after point-shaped or wide surface loading.

Process technologically it is advantageous if the layer of plastics of low hardness is applied by roller action. Rolling permits the application of layers within a broad spectrum of different layer thicknesses. Moreover, rolling also ensures a uniform layer application, even over the entire surface of the wooden material panel.

It is found to be advantageous if the layer of plastics is applied at a temperature of more than 80° C., preferably more than 120° C., particularly preferably at over 160° C. Within these temperature ranges, suitable plastics may be processed particularly readily, e.g. be applied in thin surface thicknesses, to dry rapidly or set rapidly and be applied at high processing rates.

Details of the invention will in the following be elucidated by way of a working example.

Onto a hard fibre board a commercially available primer layer is first applied in order to render the surface smooth. Onto the primer two varnish layers are applied in order to create a coloured decoration. Acrylic lacquers are used as varnish. Each of the layers applied so far is first cured to completion. Onto the last applied varnish layer a layer of plastics is now applied, having a Shore hardness A of 55. As a mere example for the possible composition of such a layer, the following material mixture is recited:

Acrylate dispersions: 48 parts by weight (w. %), pigments (titanium dioxide or others) 8 w. %, barium sulphate 17 w. %, kaolin 2 w. %, insulating powder 15 w. %, additives (for example thickening agent, stabilisers for the dispersions etc.) 3 w. % and water 7 w. %. The component of the material mixture here referred to as insulating powder is represented by organic particles employed as a filler and selected as a function of the desired Shore hardness A.

This plastics layer is applied with a coating thickness of 50 μm at a temperature of 150° C. At the aforementioned application temperature, the plastics coating fully cures in a short period without special measures for drying needing to be installed. Thereafter, two layers of UV-curable varnishes are applied and cured.

Alternatively, the layer may consist of a thermoplastic material. A PU-elastomer is proposed. The advantage of this material resides in the three dimensional restorative forces resulting from the material structure. Such a material may have a Shore hardness A of 35.

Processing proceeds in such a manner that the layer of PU-elastomer is applied at a temperature of 170° C. with a layer thickness of 120 μm. This is then followed by the further application of varnishes until the panel is completed.

1-19. (canceled)

20. A wooden material panel, including a surface coating applied at least on parts of the panel, said surface coating comprising at least one layer of plastics having a Shore hardness A up to 90.

21. The wooden material panel according to claim 20, wherein the Shore hardness A is up to 80.

22. The wooden material panel according to claim 20, wherein the Shore hardness A is up to 65.

23. The wooden material panel according to claim 20, wherein the Shore hardness A is up to 50.

24. The wooden material panel according to claim 20, wherein the Shore hardness A is from 20 to 60.

25. The wooden material panel according to claim 20, wherein the Shore hardness A is from 30 to 40.

26. The wooden material panel according to claim 20, wherein the panel is a ceiling panel.

27. The wooden material panel according to claim 20, wherein the panel is a floor panel.

28. The wooden material panel according to claim 20, wherein said at least one layer of plastics comprises at least one layer containing at least one thermoplastic material.

29. The wooden material panel according to claim 20, wherein said at least one layer of plastics comprises at least one layer containing a mixture of plastics including at least one thermoplastic material.

30. The wooden material panel according to claim 20, including at least one layer of plastics made of at least one of a polyolefin, a reactive polyolefin, a polyurethane, an ethylene-vinyl-acetate, polyester, an epoxide, and mixtures thereof.

31. The wooden material panel according to claim 20, wherein said at least one layer of a plastics is at least one of colored and transparent and filled with a mineral or an organic filler.

32. The wooden material panel according to claim 20, wherein the at least one layer of plastics has a thickness between 20 μm and 300 μm.

33. The wooden material panel according to claim 20, wherein the at least one layer of plastics has a thickness up to 40 μm.

34. The wooden material panel according to claim 20, wherein the at least one layer of plastics has a thickness up to 70 μm.

35. The wooden material panel according to claim 20, wherein the at least one layer of plastics has a thickness up to 100 μm.

36. The wooden material panel according to claim 20, wherein the at least one layer of plastics has a thickness up to 150 μm.

37. The wooden material panel according to claim 20, wherein the at least one layer of plastics has a thickness up to 250 μm.

38. The wooden material panel according to claim 20, wherein the at least one layer of plastics forms part of a multiple layer surface coating on a surface of the wooden material panel.

39. The wooden material panel according to claim 38, wherein the at least one layer of plastics is an externally exposed layer or a non-externally exposed layer.

40. The wooden material panel according to claim 20, wherein at least two layers of plastics have been applied onto the wooden material panel.

41. The wooden material panel according to claim 40, wherein at least one layer of plastics has been applied onto each main surface of the wooden material panel.

42. The wooden material panel according to claim 20, wherein at least two layers of plastics have been applied onto at least one main surface of the wooden material panel.

43. The wooden material panel according to claim 42, wherein between the at least two layers of plastics at least one layer of another material having a different Shore hardness A is provided.

44. The wooden material panel according to claim 38, wherein the at least one layer of plastics borders onto a layer of synthetic resin.

45. The wooden material panel according to claim 44, wherein the layer of synthetic resin is a varnish layer.

46. The wooden material panel according to claim 38, wherein the at least one layer of plastics borders onto a layer of paint.

47. The wooden material panel according to claim 38, wherein the at least one layer of plastics has been coated onto a layer of bonding agent.

48. The wooden material panel according to claim 38, further comprising a layer of bonding agent applied onto the at least one layer of plastics.

49. The wooden material panel according to claim 20, wherein the at least one layer of plastics is elastic and resumes its original shape after a mechanical load is removed which had resulted in a deformation.

50. A process for the manufacture of a wooden material panel, including a surface coating comprising applying at least one layer of plastics having a Shore hardness A of up to 90 to a surface of the wooden material panel.

51. The process of claim 50, wherein the applying step comprises applying at least one layer of plastics having a Shore hardness A of up to 80.

52. The process of claim 50, wherein the applying step comprises applying at least one layer of plastics having a Shore hardness A of up to 65.

53. The process of claim 50, wherein the applying step comprises applying at least one layer of plastics having a Shore hardness A of up to 50.

54. The process of claim 50, wherein the applying step comprises applying at least one layer of plastics having a Shore hardness A of from 20 to 60.

55. The process of claim 50, wherein the applying step comprises applying at least one layer of plastics having a Shore hardness A of from 30 to 40.

56. The process according to claim 50, wherein said applying step comprises applying the at least one layer of plastics in a thickness between 25 μm and 300 μm.

57. The process according to claim 50, wherein said applying step comprises applying the at least one layer of plastics in a thickness up to 40 μm.

58. The process according to claim 50, wherein said applying step comprises applying the at least one layer of plastics in a thickness up to 70 μm.

59. The process according to claim 50, wherein said applying step comprises applying the at least one layer of plastics in a thickness up to 100 μm.

60. The process according to claim 50, wherein said applying step comprises applying the at least one layer of plastics in a thickness up to 150 μm.

61. The process according to claim 50, wherein said applying step comprises applying the at least one layer of plastics in a thickness up to 250 μm.

62. The process according to claim 50, wherein the applying step comprises applying the at least one layer of plastics by rollers.

63. The process according to claim 50, wherein the applying step comprises applying the at least one layer of plastics at a temperature of more than 80° C.

64. The process according to claim 50, wherein the applying step comprises applying the at least one layer of plastics at a temperature above 120° C.

65. The process according to claim 50, wherein the applying step comprises applying the at least one layer of plastics at a temperature above 160° C.
